(19) United States
(12) Patent Application Publication
(10) Pub. No.: US 2014/0281219 A1
(43) Pub. Date: Sep. 18, 2014

(54) Storage Zoning Tool

(71) Applicant: Silicon Graphics International Corp., Milpitas, CA (US)

(72) Inventors: Camden Joel Mendiola, Boulder, CO (US); Jay Everett Nelson, Superior, CO (US); Michael Allen Hann, Berthoud, CO (US)

(73) Assignee: Silicon Graphics International Corp., Milpitas, CA (US)

(21) Appl. No.: 13/831,675

(22) Filed: Mar. 15, 2013

(51) Int. Cl. G06F 3/06

(52) U.S. Cl. CPC G06F 3/0689
USPC 711/114

(57) ABSTRACT

A system which semi-automates the assignment of data storage device controllers to data storage devices in a system that contains a plurality of data storage device controllers and a plurality of data storage devices. The object of the invention is to programmatically control which data storage device controllers control which specific data storage devices. The invention eliminates the need for an engineer to travel to a data center to manually reconfigure cables or interconnections between data storage device controllers and data storage devices.

### BACKGROUND OF THE INVENTION

1. Field of the Invention

The present invention generally relates to data storage device management. More specifically, the present invention relates to semi-automating the assignment of data storage device controllers to data storage devices.

2. Description of the Related Art

The modern data center contains a plurality of heterogeneous types of data storage equipment. Frequently data storage devices and data storage device controllers are enclosed within an enclosure (a box) where data storage device controllers control data storage devices that they are cabled to, or are electrically connected to through a backplane or other controller to device electrical interconnect.

An example of such an enclosure is commonly referred to as Just a Bunch of Disks (JBOD). The disks contained in a JBOD enclosure are frequently solid state disks (SSDs), conventional disk drives, or combinations of SSDs and disk drives. Typically JBOD enclosures contain little or no intelligence controlling their configuration or operation.

JBOD enclosures and similar data storage subsystems typically require an engineer to cable up or electrically attach specific data storage device controllers to specific data storage device controllers. This is a manual task that requires a trained professional engineer to perform. While this task can be completed in the factory at the time of manufacture, re-configuration in the field is frequently required.

Over the last several years, there has been an accelerating consolidation of data center hardware resources in a single physical location by vendors providing services to customers who compete with each other. What this means, for example, is that a single JBOD enclosure could be used by both Yahoo™ and by Google™. Since these companies compete with each other directly, they do not like or wish to share the same data storage device controller or data storage device with a competitor.

Thus each time, for example, Yahoo™, Google™, or another similar company requests a change in how the data center is configured an engineer would have to visit the site in person and make the appropriate changes.

There is a great need in the data center to improve the efficiency of configuring and re-configuring data storage hardware devices today. Eliminating the need for engineering service calls to reconfigure disks would save the data center thousands of dollars per service call and would reduce delays associated with such re-configurations.

### SUMMARY OF THE CLAIMED INVENTION

The invention relates to a system and method for semi-automating the assignment of data storage device controllers to data storage devices in a system that contains a plurality of data storage device controllers and a plurality of data storage devices. The invention allows an administrator or operator to programmatically control which data storage device controllers controls which specific data storage devices. The operator may administrate the mapping of data storage device controller to data storage device control associations using a software application program. This results in the elimination of in-person engineering service calls conventionally required to re-arrange cables in a data storage array. Embodiments of the invention include one or more software modules stored in memory and that operate on one or more processors including yet not limited to computers, microprocessors, field programmable gate arrays (FPGAs) configured with processor functionality, or state machines configured to control the switching of data communication signals.

Certain embodiments of the invention include an enclosure that contains a plurality of data storage device controllers and a plurality of data storage devices that are configured by an external computer through an application software program operated by an operator. In these embodiments the enclosure is essentially an array of dynamically reconfigurable data storage controllers and data storage devices that may be configured or re-configured remotely. Typically an operator would start a first module (typically the aforementioned software application program). The first module communicates with a second module stored in memory on a specific array of data storage devices and controllers and reads controller to device configuration information contained on the array of data storage devices and controllers. The operator would then use the first module (the software application program) to review controller to device assignment information. The operator could then use the first module to non-persistently update, and review the updated controller to device configuration information of the array of data storage devices and controllers. Once satisfied with the new configuration, the operator would initiate the re-configuration of the array. The first module would then communicate with the second module persistently updating the controller to device configuration information of the array data storage controllers and devices. In some instances the array would be restarted or re-boot to complete the configuration process.

In other embodiments of the invention a processor contained within the enclosure containing the array of data storage devices and controllers is used to configured to read, review, and modify configuration information describing which data storage device controllers are controlling which data storage devices contained within the enclosure. In these configurations an operator may interact with the data storage array using displays, keyboards, or other apparatus that are connected to or contained within the data storage array enclosure.

Thus some embodiments of the invention may be implemented remotely, external to the array, where other embodiments may be implemented locally, on the array itself

### BRIEF DESCRIPTION OF THE DRAWINGS

FIG. 1 is a block diagram of a set of data storage system having controllers in communication with a set of sub-assemblies.

FIG. 2 is a block diagram of a sub-assembly.

FIG. 3 is an interface for configuring zoning of a data storage system.

FIG. 4 is a method for configuring zoning of a data storage system.

FIG. 5 is a block diagram of a computing device.

### DETAILED DESCRIPTION

The present invention allows for one of more enclosures having storage devices to be zoned without requiring an in-person attention by the device manufacturer. The zoning can be configured by an administrator using an application which associates controllers within an enclosure to selected storage devices. An embodiment of the invention includes a data storage system including one or more enclosures, each enclosure having a plurality of controllers and storage devices. The storage devices are selectable and can be zoned for use with a particular controller within the enclosure. Each enclosure may include a plurality of sub-assemblies, each of which include a plurality of storage devices and one port expander. Controllers may be a serially attached SCSI (SAS) controller within the enclosure may communicate with each expander.

Unlike zoned data storage enclosures of the prior art, all controllers are connected to each and every sub-block within the enclosure. Each controller only has access to sub-assembly storage devices if the sub-assembly port expander .BIN file indicates that the controller and particular storage device are in the same zone.

The zoning can be configured from a computer in communication with the enclosures. The zoning may involve selecting one or more drives in communication with an expander to communicate with a particular controller. An interface may be provided by a zoning application to enable an administrator to select what drives will be zoned with each controller. To effectuate the zoning, a file at each expander may be accessed and modified, and the modified file may then be stored at the expander. By allowing administrators to configure storage device zoning using an interface at a computer, a technician is not required to make an in-person visit each time zoning needs to be changed.

In some embodiments, the zoning application may include one or more modules which are executable to access a zoning configuration file from the data storage system. In embodiments, the zoning configuration file may include a .BIN file stored on an expander within a sub-assembly of the enclosures. The zoning application may retrieve the .BIN file having the current zoning information and converts the file into another file format, such as for example an XML file.

The zoning application provides an interface to an administrator which communicates the current zoning setup and allows the administrator to modify the zoning configuration. The zoning configuration may be changed by specifying what storage devices, such as hard disk drives within each sub-assembly, may communicate with a particular controller. The zoning application may update the XML file with administrator changes to the zoning configuration, and may convert the updated XML file into a new .BIN file. The zoning application may then transmit the .BIN file back to the corresponding expander, and persistently change the zoning configuration. With the new .BIN file in place, controllers may be able to communicate with storage devices as configured by the administrator.

FIG. 1 is a block diagram of a set of data storage system having controllers in communication with a set of sub-assemblies. The system of FIG. 1 includes enclosures 110, 120 and 130 and client computer 140. Enclosure 110 includes four SAS controllers 112. Each SAS controller may communicate with 8 sub-assemblies 114 within enclosure 110. Each sub-assembly includes an expander 116. Controllers 112 may communicate with each expander. Typically, a plurality of cables is manually installed when connecting particular controllers to one or more particular storage devices.

Though three enclosures, each with four controllers and eight assemblies and expanders are illustrated in FIG. 1, this is for purposes of discussion only. The present zoning configuration technology may work with any number of enclosures, each having any number of controllers, subassemblies and expanders. Sub-assemblies are discussed in more detail with respect to FIG. 2.

Client computer 140 may include zoning application 145. Zoning application 145 may be stored in memory on client computer 140 and is executable to configure zoning of enclosures 110-130. Zoning application 145 may be stored on a computing device in direct communication with enclosures 110-130. Zoning application 145 may also be stored “on the cloud” and/or execute as a network application (e.g., web application) to communicate with enclosures 110-130. The zoning application may retrieve one or more configuration files from each expander. The zoning application may convert each retrieved file to other file formats and communicate zoning information included within each file to a user through an interface or other mechanism. The zoning application may update the converted file with any zoning changes requested by the user through an interface provided by the application, and convert the file back to its original format—but with changes reflecting new zoning configurations. The zoning application may transmit updated files to be stored in the corresponding expander.

When the expander receives a file with updated zoning configuration information, the expander will allow access to storage devices in its corresponding sub-assembly only to the controller indicated to have access in the file.

FIG. 2 is a block diagram of a sub-assembly. The sub-assembly 210 of FIG. 2 includes an expander 220 and a number of storage devices 230. In the exemplary sub-assembly of FIG. 2, the storage devices include hard disk drives and nine of hard disk drives exist within sub-assembly. Expander 220 may communicate with each of the nine storage devices 230. In embodiments, expander 220 may communicate with each and every storage device 230 on behalf of each controller in the enclosure which includes sub-assembly 210—hence the four lines of communication extending from expander 220 to each storage device 230.

As mentioned above, a zoning application may provide an interface for allowing an administrator to configure zoning within one or more enclosures. FIG. 3 is an interface for configuring zoning of a data storage system. The interface may be provided by zoning application 145.

The zoning interface includes an upper menu and adaptor/controller selection tabs below the upper menu. Each adaptor/controller tab corresponds to an interface page (“controller page”) for configuring which storage devices will be zoned for an adaptor/controller. Each controller page provides a visual representation of each sub-assembly (labeled “bricks” in the interface) and the storage devices of each assembly. For example, for the controller page illustrated for adaptor/controller 0, eight sub-assemblies (“bricks”) are illustrated, with each sub-assembly including nine selectable storage devices. Each sub-assembly may also include a select all and unselect all button, for selecting or deselecting every storage device within the sub-assembly. In some embodiments, only one controller can be coupled with a particular storage device. So, if controller 1 is coupled to storage devices 1-6 on the controller page for controller 1, then those storage devices may not be selected in the controller page for controllers 0, 2, and 3.

Below the sub-assembly information is an information window which provides data such as sub-assembly SAS address information. Other information may be provided in the information window as well. Below the information window is a set of operation buttons. The operation buttons include “Show All”, “Create New Session”, Save Session”, “Download Session”, and “Exit.” The “Show All” button may allow an administrator to see all sub-assembly information for all the controllers on a single screen. The “Create New Session” button may create a new zoning configuration session. The “Save Session” button saves the configuration information currently selected for each controller to the enclosure. When selected, the selections are stored in an .XML file for each controller, the files are converted to .BIN files, and the .BIN files are transmitted to the expanders for each sub-assembly. The “Download Session” may download the current settings from an enclosure. When selected, the zoning application may retrieve the zoning configuration files (e.g., .BIN files) from the expanders, convert them to an alternative format (such as XML), and load the zoning configuration information into the interface. The “Exit” button ends the current session.

There may be additional features implemented by the zoning application 145. For example, when a storage device is selected within a currently displayed controller page but was already selected to communicate with another controller, a confirmation message may be provided to confirm the administrator wishes to change the zoning for the particular storage device.

Additionally, the .BIN file may contain large amounts of information, about zone configuration and other data. The zoning application may confirm that the .BIN file does not have errors and is only modified with respect to zoning information.

FIG. 4 is a method for configuring zoning of a data storage system. The method of FIG. 4 may be performed by zoning application 145, except 600 which is performed by one or more expanders receiving a new .BIN file.

First a zoning application is initialized at step 410. Initializing may include performing start-up, an optional login, and other tasks as the application boots-up. A determination is made as to whether an administrator would like to start a new session (by pressing the “New Session” button in the interface of FIG. 3) or a session is downloaded (pressing “Download Session” button) at step 420. If a new session is started, the method of FIG. 4 continues to step 460.

If a new session is started, a .BIN session is retrieved from enclosure expanders at step 430. The retrieved .BIN file is converted to .XML format at step 440. The interface provided by zoning application 145 is populated with zoning configuration information at step 450. Population of the interface may include selecting checkboxes next to storage devices that are zoned for a particular controller.

Updates may be received to zoning configurations through the interface at step 460. The updates may be received by receiving selections of storage devices in order to zone them with a particular controller in the interface of FIG. 3. The zoning configuration changes are stored to an XML file at step 470. The XML file is then converted into a new .BIN file at step 480. The new .BIN file is transmitted to the appropriate port expanders at step 490. The port expander then loads the new .BIN file at step 600. Each expander will then allow communication and usage of storage drives with controllers which are in a zone with the controller according to the expander's .BIN file.

FIG. 5 is a block diagram of a computing device. FIG. 5 illustrates an exemplary computing system 500 that may be used to implement a computing device for use with the present technology. System 500 of FIG. 5 may be implemented in the contexts of the likes of client device 140 in the system of FIG. 1. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims

The invention thus enables on the fly changes in the configuration of data storage device controller to data storage device programmatically eliminating the delays and costs associated with sending an engineer to the data center. The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claims and otherwise appreciated by one of ordinary skill in the art

What is claimed is:

1. A method for configuring data storage zones, comprising:
receiving input by an application stored in memory and executed by a processor to configure a zoning configuration for an enclosure having a plurality of storage devices and controllers, wherein each storage device may be in a zone with only one controller; and.
transmitting zoning configuration data based on the input to the enclosure to create storage zones for the storage devices.

2. The method of claim 1, further comprising:
storing the input as an XML file; and
converting the XML file to a .BIN file, the .BIN file including the zoning configuration data and transmitted to the enclosure.

3. The method of claim 1, further comprising retrieving the current zoning information as a first .BIN file from a port expander within the enclosure, the input included updates received to change the current zoning information

4. The method of claim 3, further comprising:
converting the first .BIN file to an XML file; and
populating the interface with zoning configuration information retrieved from the XML file.

5. The method of claim 1, wherein the zoning configuration identifies storage devices in the enclosure which are selected to communicate with a particular controller from a plurality of controllers within the enclosure.

6. The method of claim 1, wherein every controller in the enclosure is connected to every port expander in the enclosure.

7. A computer readable non-transitory storage medium having embodied thereon a program, the program being executable by a processor to perform a method for configuring data storage zones, the method comprising:
receiving input to configure a zoning configuration for an enclosure having a plurality of storage devices and controllers, wherein each storage device may be in a zone with only one controller; and.
transmitting zoning configuration data based on the input to the enclosure to create storage zones for the storage devices.

8. The computer readable non-transitory storage medium of claim 1, the method further comprising:
storing the input as an XML file; and
converting the XML file to a .BIN file, the .BIN file including the zoning configuration data and transmitted to the enclosure.

9. The computer readable non-transitory storage medium of claim 1, the method further comprising retrieving the current zoning information as a first .BIN file from a port expander within the enclosure, the input included updates received to change the current zoning information

10. The computer readable non-transitory storage medium of claim 9, the method further comprising:
converting the first .BIN file to an XML file; and
populating the interface with zoning configuration information retrieved from the XML file.

11. The computer readable non-transitory storage medium of claim 1, wherein the zoning configuration identifies storage devices in the enclosure which are selected to communicate with a particular controller from a plurality of controllers within the enclosure.

12. The computer readable non-transitory storage medium of claim 1, wherein every controller in the enclosure is connected to every port expander in the enclosure.

13. A system for configuring data storage zones, including:
a client computer including a processor, memory, and a zoning application stored on the processor; and
a data storage enclosure including a plurality of data storage devices, controllers and port extenders,
the zoning application executable to retrieve zoning configuration data from the port extenders, modify the zoning configuration data, and transmit the modified zoning configuration data to be loaded into the port expanders.

14. The system of claim 13, wherein the data storage expanders include a plurality of sub-assemblies, each sub-assembly including one of the plurality of port expanders and one or more storage devices.

15. The system of claim 13, wherein the storage devices include hard disk drives.

16. The system of claim 13, wherein the controllers are SAS controllers.
